(19) United States
(12) Patent Application Publication
(10) Pub. No.: US 2023/0214249 A1
(43) Pub. Date: Jul. 6, 2023

(54) MULTIPLE READER/WRITER MODE FOR CONTAINERS IN A VIRTUALIZED COMPUTING ENVIRONMENT

(71) Applicant: VMWARE, Inc., Palo Alto, CA (US)

(72) Inventor: KASHISH BHATIA, Bangalore (IN)

(21) Appl. No.: 17/680,355

(22) Filed: Feb. 25, 2022

(30) Foreign Application Priority Data
Jan. 5, 2022 (IN) 202241000550

(51) Int. Cl. G06F 9/455; G06F 3/06

(52) U.S. Cl. CPC G06F 9/45558; G06F 3/0655; G06F 3/0664; G06F 3/0604; G06F 3/067; G06F 2009/45583

(57) ABSTRACT

Multiple stateful virtualized computing instances (e.g., containers) are provided with concurrent access (e.g., read and/or write access) to a shared persistent storage location, such as a persistent volume (PV). This multiple-access capability is provided by a container volume driver that generates and maintains an interval tree data structure for purposes of tracking and managing attempts by containers to simultaneously read/write to the PV.

### RELATED APPLICATION

Benefit is claimed under 35 U.S.C. 119(a)-(d) to Foreign Application serial no. 202241000550 filed in India entitled “MULTIPLE READER/WRITER MODE FOR CONTAINERS IN A VIRTUALIZED COMPUTING ENVIRONMENT”, on Jan. 5, 2022, by Vmware, Inc., which is herein incorporated in its entirety by reference for all purposes.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualization computing instances such as virtual machines (VMs) running different operating systems may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A virtual machine running on a host is one example of a virtualized computing instance or workload. A virtualized computing instance may represent an addressable data compute node or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. As an example deployment of containers in a virtualized computing environment, the containers can be logically grouped or deployed in one or more VMs, and/or arranged in clusters or other configurations.

Initially, containers were stateless. However, many current applications require the state of a container to be stored. A challenge is that stateful containers have very limited access controls (e.g., access control lists or ACLs) available, and that stateful containers need to have persistent storage. The persistent storage for containers in a virtualized computing environment may be provided via a persistent volume (PV) provisioned from virtual storage resources, such as virtual machine disks (VMDKs) or first class disks (FCDs).

If a PV is shared amongst containers, current designs enable only one container at a time to mount the PV in writer mode (write-access mode). To do so, that container should be cluster-aware and should instruct other containers to disable their write-access mode by remounting the shared PV in read-only mode. Such design limitations are sub-optimal and impose problems when multiple containers need to concurrently access and update the data in the shared PV, for example, by slowing down the write processing on the shared PV.

### BRIEF DESCRIPTION OF DRAWINGS

FIG. 1 is a schematic diagram illustrating an example virtualized computing environment that supports a multi-access mode for virtualized computing instances;

FIGS. 2 and 3 are schematic diagrams illustrating example arrangements of containers in the virtualized computing environment of FIG. 1 that may operate with the multi-access mode;

FIG. 4 is a diagram illustrating an example interval tree data structure that may be used for the multi-access mode;

FIG. 5 is a flowchart of an example method to manage multiple concurrent accesses of a shared persistent volume by virtualized computing instances depicted in FIGS. 1 and 2; and

FIGS. 6-9 are diagrams illustrating example accesses of a shared persistent volume by multiple containers.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses some of the above-described and other drawbacks associated with enabling multiple stateful virtualized computing instances (e.g., containers) to have concurrent access (e.g., read and/or write access) to a shared persistent storage location, such as a persistent volume (PV). This multiple-access (multi-access) capability may be provided in the techniques disclosed herein by way of a container volume driver that generates and maintains an interval tree data structure for purposes of managing attempts by containers to simultaneously read/write to the PV.

According to various embodiments, a method allows multiple containers to open the shared PV in write mode and to update the shared PV simultaneously. To accomplish this, the container volume driver is able to handle/detect multiple write requests from different containers, and to use the interval tree data structure to determine whether the write requests involve one or more overlapping offset addresses in the PV. The container volume driver may allow concurrent write requests to be performed, for example, when the offset addresses involved in the write requests are non-overlapping. The container volume driver may also allow write requests when an address range (involved in the write request) in the PV is not currently in use by an active owner/container.

Computing Environment

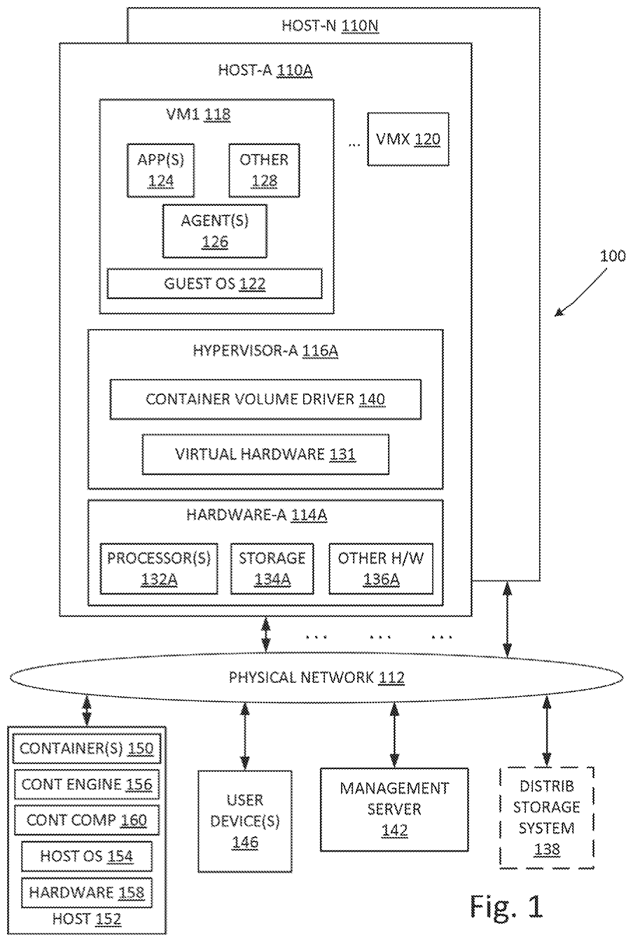

To further explain the operation and elements of a solution to enable multiple concurrent access to a shared persistent storage location, various implementations will now be explained in more detail using FIG. 1, which is a schematic diagram illustrating an example virtualized computing environment 100 that supports a multi-access mode for virtualized computing instances. For the purposes of explanation, some elements are identified hereinafter as being one or more of: plug-ins, application program interfaces (APIs), subroutines, applications, background processes, daemons, scripts, software modules, engines, orchestrators, managers, drivers, user interfaces, agents, proxies, services, or other type or implementation of computer-executable instructions stored on a computer-readable medium and executable by a processor. Depending on the desired implementation, virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include some substantially similar elements and features, unless otherwise described herein.

The host-A 110A includes suitable hardware 114A and virtualization software (e.g., a hypervisor-A 116A) to support various virtual machines (VMs). For example, the host-A 110A supports VM1 118 . . . VMX 120, wherein X (as well as N) is an integer greater than or equal to 1. In practice, the virtualized computing environment 100 may include any number of hosts (also known as computing devices, host computers, host devices, physical servers, server systems, physical machines, etc.), wherein each host may be supporting tens or hundreds of virtual machines. For the sake of simplicity, the details of only the single VM1 118 are shown and described herein.

VM1 118 may be a guest VM that includes a guest operating system (OS) 122 and one or more guest applications 124 (and their corresponding processes) that run on top of the guest operating system 122. VM1 118 may include one or more agent(s) 126, including one or more agents to issue read/write requests or otherwise manage access to storage resources by VM1 118 and/or to perform other operations. VM1 118 may include still further other elements 128, such as binaries, libraries, and various other elements that support the operation of VM1 118.

In some embodiments, one or more of VM1 118 . . . VMX 120 on host-A 110A may run/support containers, such as in a containers-on-virtual-machine configuration. For example, the other element(s) 128 of a VM may include a container engine (on top of the guest OS 122) that builds, runs, and maintains one or more containers on the VM. The containers in turn share the guest OS 122 with each other and have their separate binaries/libraries, with each of these containers running as isolated processes (e.g., executing a respective application 124). As used herein, the term container (also known as a container instance) is used generally to describe an application that is encapsulated with all its dependencies (e.g., binaries, libraries, etc.).

A container volume agent (e.g., the agent 126) may be provided for each VM that runs container(s), so as to manage read/write requests by the containers to access a shared PV. It is possible to provide a configuration wherein some of the VMs on a host are not running containers while other VMs on the host are running containers, all of the VMs on the host are running containers, or none of the VMs on the host are running containers.

The hypervisor-A 116A may be a software layer or component that supports the execution of multiple virtualized computing instances. Hypervisor 116A may run on top of a host operating system (not shown) of the host-A 110A or may run directly on hardware 114A. The hypervisor 116A maintains a mapping between underlying hardware 114A and virtual resources (depicted as virtual hardware 131) allocated to VM1 118 and the other VMs.

A container volume driver 140 may reside in the hypervisor-A 116A or elsewhere in the host-A 110. The container volume driver 140 of various embodiments may be in the form of a plug-in, and as will be further described in detail later below, configured build and maintain an interval tree data structure, and to manage access (e.g., for read/write purposes) by containers to a shared PV, such that the containers may perform concurrent read/write operations on data in the shared PV, when appropriate and without conflicts.

According to some embodiments, the container volume driver 140 may cooperate with the container volume agent (e.g., the agent 126 such as previously discussed above) to manage and process read/write requests to the shared PV. In some embodiments, the container volume agent 126 may comprise part of the container volume driver 140 (e.g., is a sub-component thereof).

Hardware 114A in turn includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 131) are allocated to each container and/or to each virtual machine to support a guest operating system (OS) and application(s) in the virtual machine, such as the guest OS 122 and the applications 124 (e.g., a word processing application, accounting software, a browser, etc.). Corresponding to the hardware 114A, the virtual hardware 130 may include a virtual CPU (including a virtual graphics processing unit (vGPU)), a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 138 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource 134A of the host-A 110A and the corresponding storage resource of each of the other hosts) can be aggregated together to form the distributed storage system 138 that is accessible to and shared by each of the host-A 110A . . . host-N 110N. In this manner, the distributed storage system 138 is shown in broken lines in FIG. 1, so as to symbolically represent that the distributed storage system 138 is formed as a virtual/logical arrangement of the physical storage devices (e.g., the storage resource 134A of host-A 110A) located in the host-A 110A . . . host-N 110N. However, in addition to these storage resources, the distributed storage system 138 may also include stand-alone storage devices that may not necessarily be a part of or located in any particular host.

The distributed storage system 138 can be used to provide virtual storage resources for the containers, such as virtual machine disks (VMDKs) or first class disks (FCDs). A subset of the VMDKs/FCDs can in turn be allocated for persistent storage (e.g., a shared PV) for the containers.

The host-A 110A has been described above as running the virtual machines VM1 118 . . . VMX 120, some of which in turn may run containers. One or more other hosts in the cluster of host-A 110A . . . host-N 110N may also run containers. An example is separately shown in FIG. 1 as the host 152.

In the container configuration for the host 152, one or more containers 150 can run on the host 152 and share a host OS 154 with each other, with each of the containers 150 running as isolated processes. The containers 150 and their corresponding container engine 156 can use hardware 158 of the host 152 directly, without implementing a hypervisor, virtual machines, etc. in this example. The container engine 156 may be used to build and distribute the containers 150. The container engine 156 and related container technology is available from, among others, Docker, Inc.

The host 152 may further include one or more container components, generally depicted at 160. The components 160 of one embodiment may include a container volume driver, analogous to the container volume driver 140 described above with respect to the host-A 110A.

A management server 142 of one embodiment can take the form of a physical computer with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster. The functionality of the management server 142 may be accessed via one or more user devices 146 that are operated by a user such as a system administrator. For example, the user device 146 may include a web client (such as a browser-based application) that provides a user interface operable by the system administrator to view and monitor the operation (such as storage-related operations) of the containers and VMs, via the management server 142.

The management server 142 may be communicatively coupled to host-A 110A . . . host-N 110N (and hence communicatively coupled to the virtual machines, hypervisors, containers, hardware, etc.) via the physical network 112. The host-A 110A . . . host-N 110N may in turn be configured as a datacenter that is managed by the management server 142, and the datacenter may support a web site. In some embodiments, the functionality of the management server 142 may be implemented in any of host-A 110A . . . host-N 110N, instead of being provided as a separate standalone device such as depicted in FIG. 1.

Depending on various implementations, one or more of the physical network 112, the management server 142, the host 152, the distributed storage system 138, and the user device(s) 146 can comprise parts of the virtualized computing environment 100, or one or more of these elements can be external to the virtualized computing environment 100 and configured to be communicatively coupled to the virtualized computing environment 100.

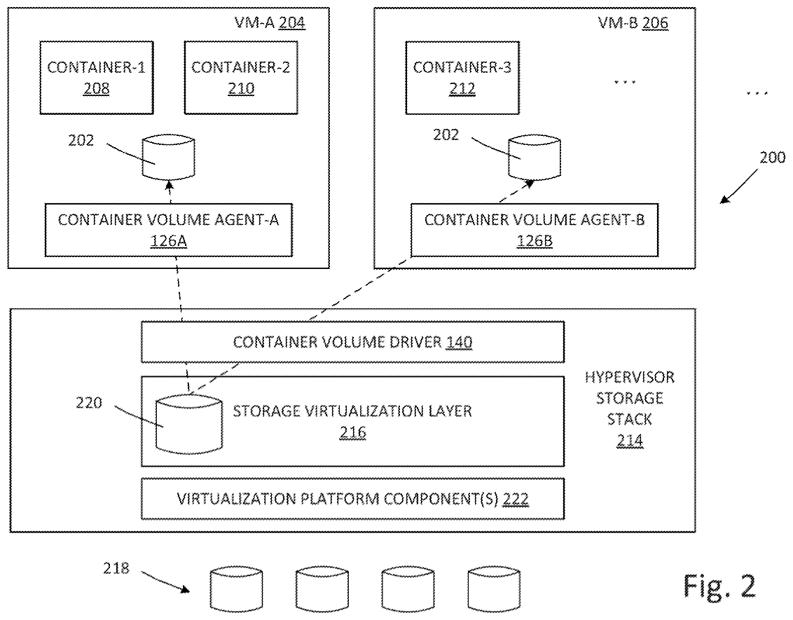

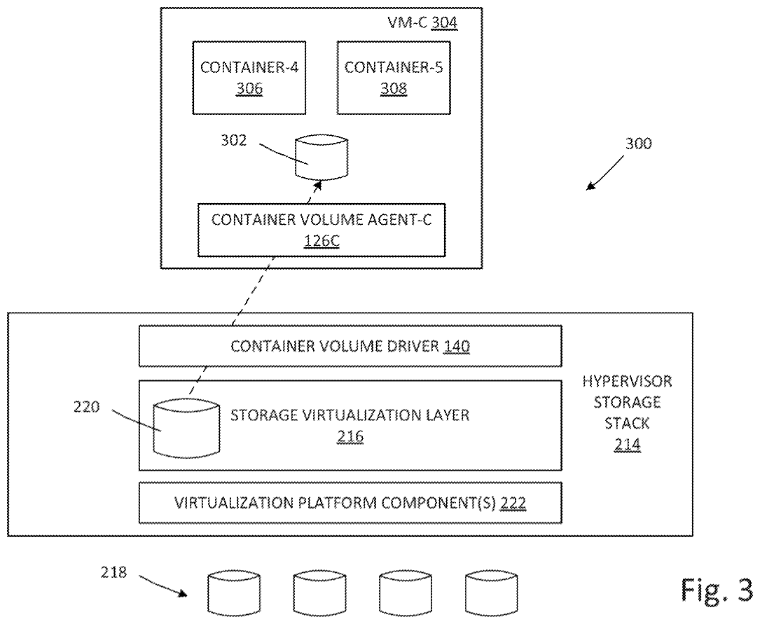

FIGS. 2 and 3 are schematic diagrams illustrating example arrangements of containers in the virtualized computing environment 100 of FIG. 1 that may operate with the multi-access mode. More specifically, FIGS. 2 and 3 show examples of containers-on-virtual-machine configurations.

With respect to FIG. 2, FIG. 2 shows an arrangement 200 wherein a single/same persistent volume (PV) 202 is shared between multiple VMs (e.g., VM-A 204, VM-B 206, etc.), and is in turn shared between the containers that run in these VMs. These VMs may reside on the same host or different hosts. VM-A 204 runs container-1 208, container-2 210, etc., and a container volume agent-A 126A resides in VM-A 204. Analogously, VM-B 206 runs container-3 212, etc., and a container volume agent-B 126B resides in VM-B 206.

A hypervisor storage stack 214 (e.g., a storage stack of a hypervisor residing on the same host or a different host than the host that runs the depicted VMs) includes a container volume driver 140 (described previously above with respect to FIG. 1), a storage virtualization layer 216 that virtualizes physical storage 218 into virtual storage disk 220, and virtualization platform component(s) 222 to support various other functions/operations of the hypervisor. The virtual storage disk 220 may include, for example, VMDKs, FCDs, etc.

With respect to FIG. 3, FIG. 3 shows an arrangement 300 wherein a persistent volume (PV) 302 is allocated to a single VM (e.g., VM-C 304), and is in turn shared between the containers (e.g., container-4 306 and container-5 308) that run in VM-C 304. A container volume agent-C 126C resides in VM-C 304. The various other elements shown in FIG. 3 (e.g., a container volume driver 140 and other components of a hypervisor storage stack) are similar/same as those shown with respect to FIG. 2, and so their description is not repeated herein.

Multiple Reader/Writer Mode for Containers

The container volume driver 140 of various embodiments can provide multiple reader/writer capability (e.g., a multi-access mode) for containers, for instance by generating and maintaining an interval tree data structure. The use of the interval tree data structure helps to ensure that there are no conflicts/inconsistencies in situations when multiple containers attempt to perform concurrent and/or sequential read/write operations on a shared PV. Among other things and for example, the container volume driver 140 may use the interval tree data structure to track/manage which particular storage region (e.g., particular address range or addresses) of the PV is currently in use by a container, which containers are requesting read/write access to the storage region, when read/write requests are sent by containers via their respective container volume agent 126, whether an access request is a read request or a write request, whether a current read/write operation on a storage region (addresses) in the PV is completed or is still in progress, etc.

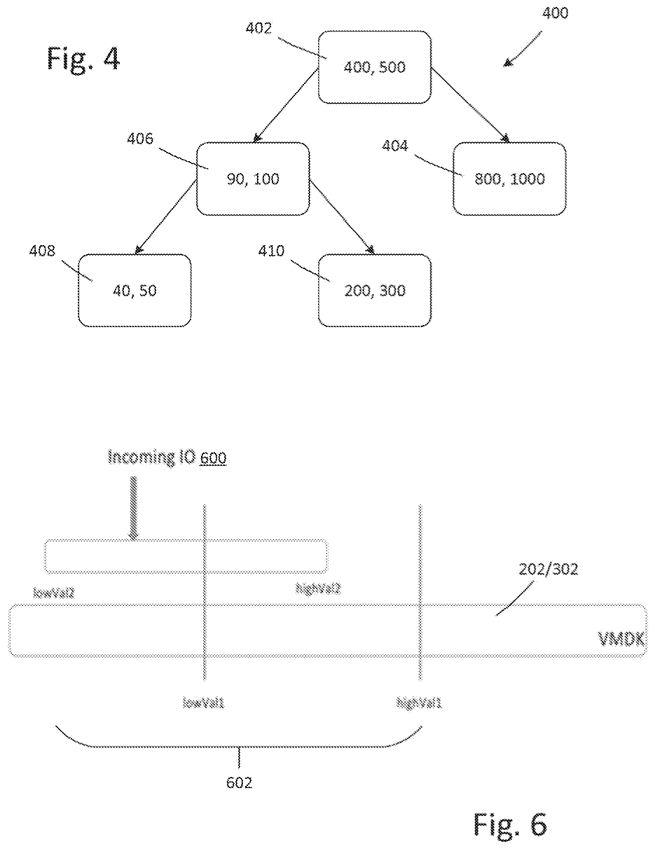

FIG. 4 is a diagram illustrating an example interval tree data structure 400 that may be used for the multi-access mode. The interval tree data structure 400 of various embodiments may use the properties of a red-black tree for purposes of balancing read/write request, and also to detect and handle concurrent requests that involve overlapping storage regions in a PV. The container volume driver 140 can store/track the active input/output (I/O) requests (e.g., read/write requests) on the shared PV by maintaining the non-overlapping offset address ranges in the interval tree data structure 400.

In the example interval tree data structure 400 of FIG. 4, a root node 402 contains/specifies offset addresses 400 (left) and 500 (right). A first (right) child branch 404 off the root node 402 (parent node) contains/specifies addresses 800 (left) and 1000 (right), both of which are greater than the address 500 (right) of the immediate parent root node 402. These various left/right addresses in the interval tree data structure 400 may be start/end addresses of an address range in some embodiments.

A second (left) child branch 406 off the root node 402 contains/specifies addresses 90 (left) and 100 (right), both of which are lesser than the address 400 (left) of the immediate parent root node 402. The branch 406 in turn is the parent branch for further child branches 408 and 410. The left branch 408 contains/specifies addresses 40 (left) and 50 (right), both of which are lesser than the address 90 (left) of the immediate parent node (branch 406). The right branch 410 contains/specifies addresses 200 (left) and 300 (right), both of which are greater than the address 100 (right) of the immediate parent node (branch 406).

Thus and as depicted in FIG. 4, the container volume driver 140 may use the interval tree data structure 400 to maintain and track non-overlapping address ranges of storage regions of a shared PV, and to also track/maintain other information related to concurrent read/write requests/usage of the storage regions of the shared PV. According to various embodiments, the container volume driver 140 may generate/maintain the following example layout and information for each node of the interval tree data structure 400:

```
Struct IntervalTreeNode {
  struct listLink links;
  int lowVal;
  int highVal;
  int accessMode;
  string owner[ ];
}
```

In the foregoing example, Link is the address location of the right/left node of the interval tree data structure 400 to navigate to; lowVal is the starting offset address of a read or write request; highVal is the end offset address of a read or write IO/request; accessMode indicates the type of I/O request (e.g., a read request or a write request); and owner stores the unique owner name (e.g., unique names of containers, described below) who is accessing the range of addresses in the storage region/block of the shared PV as specified in the node.

With respect to the unique owner name of each container, for use by the container volume driver 140 to track/monitor access to the shared PV, the unique owner name can have the following example form/content:
ContainerID—vmID—volName—diskID

Containers are each assigned with a unique container ID (ContainerID in the unique owner name above) by the guest operating system of the VM. Also in the virtualized computing environment 100, each guest VM and virtual storage disk (e.g., VMDK, FCD, etc.) is assigned with a universally unique identifier (UUID), which are vmID and diskID, respectively, in the unique owner name above. The shared PV advertised by the container volume driver 140 to the containers is assigned a name (which may or may not be unique), which is volName in the unique owner name above. Thus, the unique owner name above can be constructed by the container volume driver 140, by appending the UUIDs/names of all four components contributing to the I/O: the container, the VM, the PV, and the virtual storage disk.

Since the container volume driver 140 sits between the container layer (e.g., the containers 208, 210, 212, 306, 308, etc.) and the backend storage virtualization layer 216, the container volume driver 140 is aware about both the source and the destination of a read/write request (I/O request). In response to receiving the I/O request, the container volume driver 140 constructs the unique owner name (which is a unique owner ID) by using the information described above.

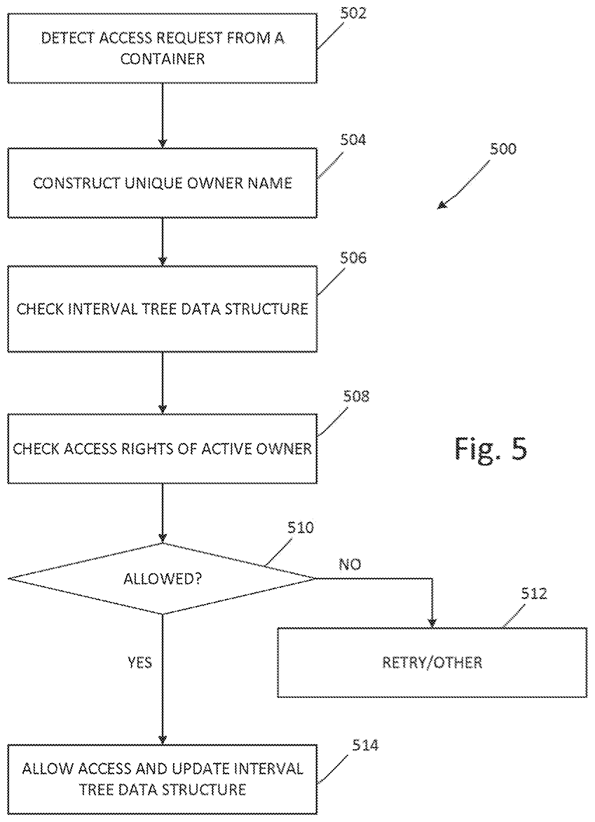

FIG. 5 is a flowchart of an example method 500 to manage multiple concurrent accesses of a shared persistent volume by virtualized computing instances depicted in FIGS. 1 and 2. For example, the method 500 of FIG. 5 may be performed by the container volume driver 140 at a host to detect, grant/deny, or otherwise manage multiple read/write requests (I/O requests) sent by containers (via their respective container volume agent 126) for purposes of concurrently accessing a shared PV.

The example method 500 may include one or more operations, functions, or actions illustrated by one or more blocks, such as blocks 502 to 514. The various blocks of the method 500 and/or of any other process(es) described herein may be combined into fewer blocks, divided into additional blocks, supplemented with further blocks, and/or eliminated based upon the desired implementation. In one embodiment, the operations of the method 500 may be performed in a pipelined sequential manner. In other embodiments, some operations may be performed out-of-order, in parallel, etc.

At a block 502 (“DETECT ACCESS REQUEST FROM A CONTAINER”), the container volume driver 140 detects an access request (e.g., an I/O request such as a read request or a write request) issued by an application running in a container. The access request from the particular requesting container is directed towards the shared PV of the container that is backed by a virtual storage disk allocated by a hypervisor, such as depicted in FIGS. 2 and 3.

The block 502 may be followed by a block 504 (“CONSTRUCT UNIQUE OWNER NAME”), wherein in response to detecting the access request, the container volume driver 140 constructs the unique owner name (owner ID) of the requesting container, such as previously described above, for example, by using the container ID, the VM UUID, the persistent volume name, and the UUID of the virtual storage disk (e.g., VMDK or FCD).

The block 504 may be followed by a block 506 (“CHECK INTERVAL TREE DATA STRUCTURE”), wherein the container volume driver 140 fetches the start and end offset addresses of the PV from the incoming access request. For instance, if the access request is formatted as a frame, packet, etc., the access request specifies the start address of the storage region of the PV where the container is requesting access and further specifies an offset from the start address. From the start address and the offset, the container volume driver 140 is able to determine the end address of the storage region involved in the access request. With the start address and the offset (or end address), the container volume driver 140 checks the interval tree data structure 400 to determine if there are any active owners currently working on the entire or partial address range requested by the access request.

If the container volume driver 140 determines at the block 506 that there is an active owner of the address range, then the container volume driver 140 checks the access rights and owner ID of the active owner and decides whether the access request is allowed or not, at a block 508 (“CHECK ACCESS RIGHTS OF ACTIVE OWNER”). For example at a block 510 (“ALLOWED?”), if the current owner is performing a write operation on the address range, then the requesting container may not be allowed to read or write to the address range (e.g., “NO” at the block 510). As a result, the container volume driver 140 may deny access by the requesting container to the address range of the shared PV, such as by instructing the requesting container to retry or perform some other action, at block 512 (“RETRY/OTHER”). Examples of read/write conflicts and their resolution at the block 512 will be described later below.

If the container volume driver 140 determines that the requesting container is allowed simultaneous/concurrent access to the shared PV along with the current owner (“YES” at the block 510), then the container volume driver 140 updates the existing node of the interval tree data structure 400, by appending the new owner details (e.g., owner name and accessMode) to the node and also by updating the lower (lowVal) and higher (highVal) addresses, at a block 514 (“ALLOW ACCESS AND UPDATE INTERVAL TREE DATA STRUCTURE”). Examples of the updating at the block 514 will be described next.

FIGS. 6-9 are diagrams illustrating example accesses of a shared persistent volume (e.g., the PV 202/302 of FIGS. 2 and 3) by multiple containers. With reference first to FIG. 6, an incoming I/O request 600 (e.g., a read request from a particular requesting container) is directed towards a storage region having the address range between lowVal2 and highVal2. There is a current owner performing a read operation in the address range between lowVal1 and highVal1. The I/O request 600 partially overlaps near the higher offset address highVal2. The situation shown in FIG. 6 may thus be represented as follows:
If (lowVal2<lowVal1) and (highVal2<highVal1) and (highVal2>lowVal1), then the container volume driver 140 updates the lower offset address of the node of the interval tree data structure 400 to lowVal2.

Thus, the storage region where either or both the I/O request 600 and the current owner are allowed to read is between the addresses lowVal2 and highVal1, as depicted at 602 in FIG. 6. Both the requesting container and the current owner are allowed to access the overlapping region/addresses since both are performing read operations and not modifying the data.

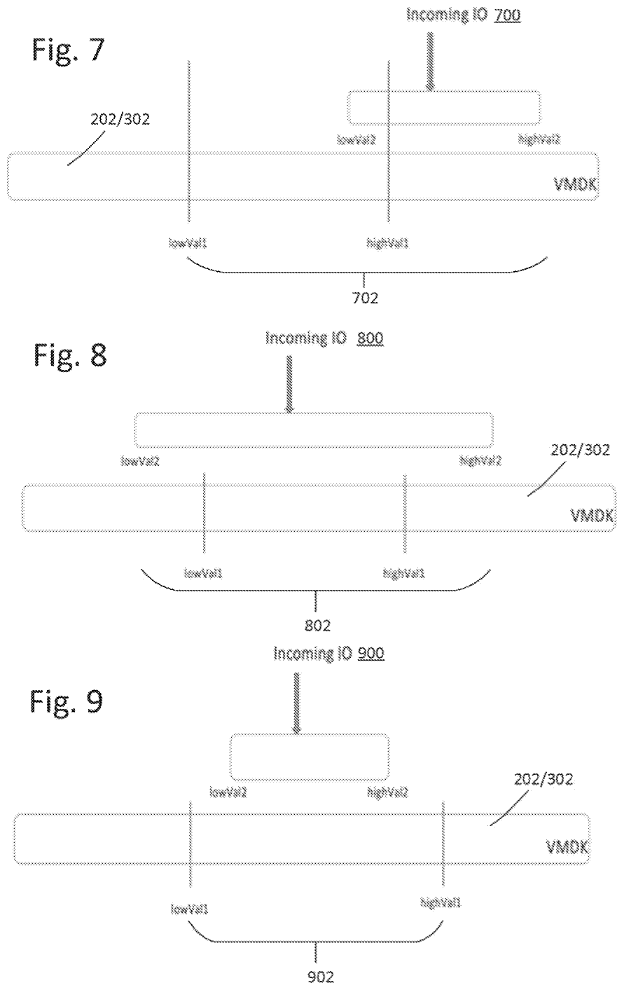

In FIG. 7, an incoming I/O request 700 (e.g., a read request from a particular requesting container) is directed towards a storage region having the address range between lowVal2 and highVal2. There is a current owner performing a read operation in the address range between lowVal1 and highVal1. The I/O request 700 partially overlaps near the lower offset address lowVal2. The situation shown in FIG. 7 may thus be represented as follows:
If (lowVal1<lowVal2) and (highVal1<highVal2) and (lowVal2<highVal1), then the container volume driver 140 updates the higher offset address of the node of the interval tree data structure 400 to high Val2.

Thus, the storage region where either or both the I/O request 700 and the current owner are allowed to read is between the addresses lowVal1 and highVal2, as depicted at 702 in FIG. 7. Both the requesting container and the current owner are allowed to access the overlapping region/addresses since both are performing read operations and not modifying the data.

In FIG. 8, an incoming I/O request 800 (e.g., a read request from a particular requesting container) is directed towards a storage region having the address range between lowVal2 and highVal2. There is a current owner performing a read operation in the address range between lowVal1 and highVal1. The I/O request 800 involves an address range that overlaps and is larger than the address range being used by the current owner. The situation shown in FIG. 8 may thus be represented as follows:
If (lowVal2<lowVal1) and (highVal1<highVal2), then the container volume driver 140 updates both the lower and higher offset addresses of the node of the interval tree data structure 400 to the address range of the incoming I/O request 800.

Thus, the storage region where either or both the I/O request 800 and the current owner are allowed to read is between the addresses lowVal2 and highVal2, as depicted at 802 in FIG. 8. Both the requesting container and the current owner are allowed to access the overlapping region/addresses since both are performing read operations and not modifying the data.

In FIG. 9, an incoming I/O request 900 (e.g., a read request from a particular requesting container) is directed towards a storage region having the address range between lowVal2 and highVal2. There is a current owner performing a read operation in the address range between lowVal1 and highVal1. The I/O request 900 involves an address range that overlaps and is smaller than the address range being used by the current owner. The situation shown in FIG. 9 may thus be represented as follows:
If (lowVal1<lowVal2) and (highVal2<highVal1), then the container volume driver 140 does not change the lower and higher offset addresses of the node of the interval tree data structure 400, but only the new owner ID of the requesting container is added to the node as an additional owner.

Thus, the storage region where either or both the I/O request 900 and the current owner are allowed to read is between the addresses lowVal1 and highVal1, as depicted at 902 in FIG. 9. Both the requesting container and the current owner are allowed to access the overlapping region/addresses since both are performing read operations and not modifying the data.

The foregoing examples of FIGS. 6-9 depict situations corresponding to blocks 510 and 514 in FIG. 5, wherein multiple readers can coexist to read an overlapping address range. The interval tree data structure 400 is updated as described above by the container volume driver 140, which also updates the maximum range of addresses accessible by all readers. This concurrent access may typically be allowed by the container volume driver 140 when both the requesting container and the current owner are performing read operations on the overlapping storage region.

If the incoming I/O request is not allowed to access the overlapping address range simultaneously with other active owners, such as in a situation wherein the incoming I/O request involves a write operation in an overlapping address range that is currently subject to a write operation or a read operation by one or more current owners, then the container volume driver 140 returns the I/O request with a failure notification and the requesting container retries the I/O request at a later time (corresponding to blocks 510 and 512 in FIG. 5). The retry attempt(s) may be performed, for example, by having the container volume driver 140 instruct the requesting container to wait for pending read/write operations to complete on the shared PV before retrying a write operation.

Various embodiments enable the container volume driver 140 to handle exclusive writes. An exclusive write may generally involve, for example, a situation wherein an address range is able to accommodate, at any point in time, only a single particular container performing a write operation—other containers may attempt to read or write to the same address range, and the container volume driver 140 manages the denial/granting of such read/write requests to avoid conflicts. Examples will be described next below.

The container volume driver 140 uses the interval tree data structure 400 to track pending I/O requests to the shared PV. For an incoming write I/O request, if the address range of the I/O request is not in use by any active owner, a new node for that address range is inserted into the interval tree data structure 400, and details related to the incoming I/O request (e.g., owner ID, access mode, start and end offset addresses of the I/O request) are added in the node. The I/O request is allowed by the container volume driver 140 (since there are no other current owners), thereby enabling the container to write data into the address range.

Write I/O requests for any non-overlapping address ranges are allowed by the container volume driver 140, so as to enable multiple containers access the shared PV simultaneously for write operations. As previously explained above, in a situation wherein there are any incoming write I/O requests that overlap on the same active address ranges (which are already servicing a write operation from a current owner), the container volume driver 140 fails the incoming write I/O request and the container/application retries the I/O at a later time.

According to some embodiments, there may be sufficient system memory (e.g., a cache) for use in storing data in the overlapped address ranges. For example, before an incoming write I/O request from a requesting container is allowed to operate on an overlapped address range, the current data in the overlapped address range is copied to the cache. Thus, before and while the requesting container performs a write operation on the current data in the overlapped address range (so as to modify that data), the current data is made available in the cache for reading by other containers.

The foregoing embodiments thus enable a subsequent read operation to be performed for the data that is/was in the overlapping address range, while a write operation on the address range is active—the cached data is returned to the container that issued the read request. These embodiments provide an opportunistic feature when memory is available for caching the data in the overlapping address ranges, such that read requests can be serviced with old/cached data while the write operation (to generate new data in the overlapping address ranges) is still incomplete. If memory is scarce/limited such that the current data is unable to be cached, then the container volume driver 140 fails subsequent read requests if the overlapping address range is being used by a writer (current owner).

After the write operation is completed in the overlapping address ranges, subsequent read requests can be directed towards the new data in the overlapping address ranges. The cached data can then be invalidated or flushed.

The techniques described herein to manage multiple concurrent readers/writers also enable the sharing of data between two containers without the use of a networking stack. Moreover, the techniques described herein improve performance since only one write operation is required on the virtual storage, whereas in a network transfer (using a network stack), multiple write operations are required to copy from a container to a network buffer and then again to copy from the network buffer to the memory of the other container.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-9. For example, computing devices capable of acting as host devices or user devices may be deployed in virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to provide an interval tree data structure to manage multiple concurrent read/write requests directed towards a shared storage location.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

What is claimed is:

1. A method for a host in a virtualized computing environment to manage concurrent access by multiple virtualized computing instances to a shared persistent storage location, the method comprising:
generating an interval tree data structure having a plurality of nodes,
wherein each node corresponds to an address range in the shared persistent storage location that is non-overlapping with address ranges corresponding to other nodes of the plurality of nodes, and
wherein each node further uniquely identifies a current owner, being one of the virtualized computing instances, of the address range corresponding to the node, and identifies an access mode of the current owner for the address range;
detecting an access request, from a particular virtualized computing instance amongst the multiple virtualized computing instances, to access a particular address range in the shared persistent storage location;
checking the interval tree data structure to determine whether to allow the access to the particular address range; and
allowing the access to the particular address range, in response to determination from the interval tree data structure that the access avoids conflict with any current owner.

2. The method of claim 1, wherein the multiple virtualized computing instances comprise multiple containers that are running on a single virtual machine or running on multiple virtual machines.

3. The method of claim 1, wherein:
the access request is a read request,
the access mode of the current owner of the address range is a read access mode to perform a read operation on the particular address range,
allowing the access to the particular address range includes allowing the read request to thereby enable the particular virtualized computing instance to read data from the particular address range concurrently with the read operation performed by the current owner, and
the method further comprises updating the interval tree data structure to indicate the particular virtualized computing instance as an additional owner of the particular address range, and to modify the particular address range.

4. The method of claim 1, wherein:
the access request is a write request, and
allowing the access to the particular address range includes allowing the write request to thereby enable the particular virtualized computing instance to write data to the particular address range, if there is no active current owner of the particular address range with a write access mode or if current owners are performing write operations on other address ranges that are non-overlapping with the particular address range.

5. The method of claim 1, wherein:
the access request is a write request, and
the method further comprises denying the access request and instructing retrying the access request at a later time, in response to the checking the interval tree data structure having determined that a current owner of the particular address range has an access mode to write to the particular address range.

6. The method of claim 1, wherein:
the access request is a write request, and
the method further comprises, prior to allowing the access request to proceed with writing to the particular address range, copying current data from the particular address range to a cache to enable the current data to be read from the cache by other virtualized computing instances before or while the current data is modified in the particular address range.

7. The method of claim 1, wherein the particular virtualized computing instance is a particular container that runs on a virtual machine, and wherein the method further comprises:
obtaining a first identifier of the particular container, a second identifier of the virtual machine, a name of the shared persistent storage location, and a third identifier of a virtual storage disk that provides the shared persistent storage location; and
generating a unique owner name that uniquely identifies the current owner, wherein the unique owner name is generated from the first, second, and third identifiers and from the name of the shared persistent storage location.

8. A non-transitory computer-readable medium having instructions stored thereon, which in response to execution by one or more processors, cause the one or more processors to perform or control performance of a method for a host in a virtualized computing environment to manage concurrent access by multiple virtualized computing instances to a shared persistent storage location, wherein the method comprises:
generating an interval tree data structure having a plurality of nodes,
wherein each node corresponds to an address range in the shared persistent storage location that is non-overlapping with address ranges corresponding to other nodes of the plurality of nodes, and
wherein each node further uniquely identifies a current owner, being one of the virtualized computing instances, of the address range corresponding to the node, and identifies an access mode of the current owner for the address range;
detecting an access request, from a particular virtualized computing instance amongst the multiple virtualized computing instances, to access a particular address range in the shared persistent storage location;
checking the interval tree data structure to determine whether to allow the access to the particular address range; and
allowing the access to the particular address range, in response to determination from the interval tree data structure that the access avoids conflict with any current owner.

9. The non-transitory computer-readable medium of claim 8, wherein the multiple virtualized computing instances comprise multiple containers that are running on a single virtual machine or running on multiple virtual machines.

10. The non-transitory computer-readable medium of claim 8, wherein:
the access request is a read request,
the access mode of the current owner of the address range is a read access mode to perform a read operation on the particular address range,
allowing the access to the particular address range includes allowing the read request to thereby enable the particular virtualized computing instance to read data from the particular address range concurrently with the read operation performed by the current owner, and
the method further comprises updating the interval tree data structure to indicate the particular virtualized computing instance as an additional owner of the particular address range, and to modify the particular address range.

11. The non-transitory computer-readable medium of claim 8, wherein:
the access request is a write request, and
allowing the access to the particular address range includes allowing the write request to thereby enable the particular virtualized computing instance to write data to the particular address range, if there is no active current owner of the particular address range with a write access mode or if current owners are performing write operations on other address ranges that are non-overlapping with the particular address range.

12. The non-transitory computer-readable medium of claim 8, wherein:
the access request is a write request, and
the method further comprises denying the access request and instructing retrying the access request at a later time, in response to the checking the interval tree data structure having determined that a current owner of the particular address range has an access mode to write to the particular address range.

13. The non-transitory computer-readable medium of claim 8, wherein:
the access request is a write request, and
the method further comprises, prior to allowing the access request to proceed with writing to the particular address range, copying current data from the particular address range to a cache to enable the current data to be read from the cache by other virtualized computing instances before or while the current data is modified in the particular address range.

14. The non-transitory computer-readable medium of claim 8, wherein the particular virtualized computing instance is a particular container that runs on a virtual machine, and wherein the method further comprises:
obtaining a first identifier of the particular container, a second identifier of the virtual machine, a name of the shared persistent storage location, and a third identifier of a virtual storage disk that provides the shared persistent storage location; and
generating a unique owner name that uniquely identifies the current owner, wherein the unique owner name is generated from the first, second, and third identifiers and from the name of the shared persistent storage location.

15. A host in a virtualized computing environment, the host comprising:
a processor; and
a non-transitory computer-readable medium coupled to the processor and having instructions stored thereon, which in response to execution by the processor, cause the processor to perform or control performance of operations to manage concurrent access by multiple virtualized computing instances to a shared persistent storage location, wherein the operations include:
generate an interval tree data structure having a plurality of nodes,
wherein each node corresponds to an address range in the shared persistent storage location that is non-overlapping with address ranges corresponding to other nodes of the plurality of nodes, and
wherein each node further uniquely identifies a current owner, being one of the virtualized computing instances, of the address range corresponding to the node, and identifies an access mode of the current owner for the address range;
detect an access request, from a particular virtualized computing instance amongst the multiple virtualized computing instances, to access a particular address range in the shared persistent storage location;
check the interval tree data structure to determine whether to allow the access to the particular address range; and
allow the access to the particular address range, in response to determination from the interval tree data structure that the access avoids conflict with any current owner.

16. The host of claim 15, wherein the multiple virtualized computing instances comprise multiple containers that are running on a single virtual machine or running on multiple virtual machines.

17. The host of claim 15, wherein:
the access request is a read request,
the access mode of the current owner of the address range is a read access mode to perform a read operation on the particular address range,
the operations to allow the access to the particular address range includes operations to allow the read request to thereby enable the particular virtualized computing instance to read data from the particular address range concurrently with the read operation performed by the current owner, and
the operations further comprise update the interval tree data structure to indicate the particular virtualized computing instance as an additional owner of the particular address range, and to modify the particular address range.

18. The host of claim 15, wherein:
the access request is a write request, and
the operations to allow the access to the particular address range includes operations to allow the write request to thereby enable the particular virtualized computing instance to write data to the particular address range, if there is no active current owner of the particular address range with a write access mode or if current owners are performing write operations on other address ranges that are non-overlapping with the particular address range.

19. The host of claim 15, wherein:
the access request is a write request, and
the operations further comprise deny the access request and instruct retrying the access request at a later time, in response to the check of the interval tree data structure having determined that a current owner of the particular address range has an access mode to write to the particular address range.

20. The host of claim 15, wherein:
the access request is a write request, and
the operations further comprise, prior to the access request being allowed to proceed with writing to the particular address range, copy current data from the particular address range to a cache to enable the current data to be read from the cache by other virtualized computing instances before or while the current data is modified in the particular address range.

21. The host of claim 15, wherein the particular virtualized computing instance is a particular container that runs on a virtual machine, and wherein the operations further comprise:
obtain a first identifier of the particular container, a second identifier of the virtual machine, a name of the shared persistent storage location, and a third identifier of a virtual storage disk that provides the shared persistent storage location; and
generate a unique owner name that uniquely identifies the current owner, wherein the unique owner name is generated from the first, second, and third identifiers and from the name of the shared persistent storage location.
